(19) United States
(12) Patent Application Publication
(10) Pub. No.: US 2006/0094635 A1
(43) Pub. Date: May 4, 2006

(54) Aqueous cleansing composition with gel flakes

(75) Inventor: Daniel Pereira, Middletown, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 10/978,511

(22) Filed: Nov. 1, 2004

(51) Int. Cl. C11D 1/66; C11D 3/22

(52) U.S. Cl. 510/470; 510/473

(57) ABSTRACT

An aqueous liquid cleansing and optional moisturizing composition is provided having a surfactant; a thickening or structuring agent, and gel flakes containing in a preferred embodiment plate-like particles. The gel flakes provide unique aesthetics to the cleansing composition. In another preferred embodiment the inventive cleansing composition includes a free skin conditioning agent having a weight average particle size in the range about 1 to about 500 microns or a clear suspending surfactant system.

### BACKGROUND OF THE INVENTION

1. Field of the Invention

The present invention relates to detergent compositions suitable for topical application for cleansing the human body, such as the skin and hair. In particular, it relates to aqueous cleansing compositions containing gel flakes associated with solid or semi-solid particles.

2. Background of the Art

In order to be acceptable to consumers, a liquid personal cleansing product must exhibit good cleaning properties, must exhibit good lathering characteristics, must be mild to the skin (not cause drying or irritation) and preferably should even provide a skin conditioning agent, a skin active agent or a blend thereof to the skin, such as moisturizers, antiwrinkle agents, skin nutrients, and the like. Several approaches have been used to provide high levels of skin conditioning agents, skin active agents or a blend thereof in a stable formula that have involved encapsulating the skin conditioning or active agent or a blend thereof which is then ruptured or dissolved with product use. For example, U.S. Pat. No. 5,932,528 to R. Glenn, Jr., et al. issued on Aug. 3, 1999 discloses a liquid cleansing composition containing a moisturizing phase comprising an encapsulated lipophilic skin moisturizing agent and an aqueous cleansing phase comprising a surfactant and a stabilizer. The encapsulated lipophilic skin moisturizing agent comprises a lipophilic skin moisturizing agent encapsulated within a complex coascervate comprising a polycation and a polyanion.

Other particles of material including microcapsules, bubbles, beads, ground particulates, and uniform particulates have been used in various cleansing and coating applications to encapsulate or bind the contents of various agents contained therein or associated therewith. For example U.S. Pat. No. 6,270,836 to Holman issued on Aug. 7, 2001 describes microcapsules coated with a gel, specifically a gel produced by the sol-gel process. The gel coating provides certain resistances to the microcapsules, resulting in enhanced protection for their contents. Microcapsules containing different types of materials are known which may be used as ingredients in the compositions of this invention, such as gelatin.

It is known that microcapsules may be formed by a coacervation or crosslinking process, in which lipids are coated by tiny droplets of proteins, carbohydrates, or synthetic polymers suspended in water. The process of coacervation is, however, difficult to control and depends on variables such as temperature, pH, agitation of the materials, and the inherent variability introduced by a natural protein or carbohydrate.

U.S. Pat. No. 6,066,613 to L. Tsaur, et al., issued on May 23, 2000; describes large hydrogel particles suspended in an aqueous medium and a continuous extrusion/mixing process for making this kind of hydrogel particles. The hydrogel particles comprise two different high molecular weight polymers. One is insoluble in the said aqueous medium and is used for network formation and gel integrity. The other is soluble in the said aqueous medium and helps control gel swellability and gel strength. Water insoluble materials are entrapped or encapsulated inside the network formed by these two polymers and are able to be more efficiently delivered from the aqueous composition (e.g., liquid cleanser containing the hydrogel particles).

U.S. Pat. No. 6,624,125 to Trage et al. Issued on Sep. 23, 2004 discloses cleansing agents which comprise matrix particles having a perfume component and a washing-active surfactant component, wherein the matrix particles preferably consist of a gelatinous polysaccharide.

Surprisingly it has been discovered that a cleansing composition containing hydrophilic polysaccharide gel flakes can be prepared wherein the flakes may be optionally associated with liquid or solid skin conditioning agent(s), skin active agent(s) or a blend thereof and wherein said flakes have particles associated with the flakes.

### SUMMARY OF THE INVENTION

In one aspect of the invention is an aqueous liquid cleansing composition including but not limited to the following:

a. at least about 0.1% by wt. of total surfactant(s) selected from an anionic, nonionic, amphoteric and cationic surfactant(s) and mixtures thereof;

b. about 0.1 to about 80% by weight of hydrophilic polysaccharide gel flakes with an average major axis of about 0.05 to about 100 millimeters in length; and

c. at least one solid or semi-solid particle having a composition different from the gel flakes contained at least partially within at least one of the gel flakes;

### DETAILED DESCRIPTION OF THE INVENTION

In one aspect of the invention is an aqueous liquid cleansing composition including but not limited to the following:
a. at least about 0.1% by wt. of total surfactant(s) selected from anionic, nonionic, amphoteric and cationic surfactant(s) and mixtures thereof;
b. about 0.1 to 80% by weight of hydrophilic polysaccharide gel flakes with an average major axis of at least 0.05 to 100 millimeters in length; and
c. wherein at least one solid or semisolid particle having a composition different from the gel flakes, preferably a flattened, plate-like particle, more preferably having an aspect ratio greater than about 20, that is contained at least partially within at least one of the gel flakes.

Major axis is herein defined as the longest dimension of the flake. Advantageously the composition has about 0.1 to 35, 40, 50, 60, or 70 wt % of total surfactants, preferably at least about 2, 3, 4, 5, 10, 15 or 20 wt % of total surfactants. More preferably the composition has less than about 1% by weight solid soap. In a preferred embodiment the composition includes an anionic surfactant and at least one cosurfactant selected from betaines, amidobetaines or sulphobetaines.

Preferably the cleansing composition further includes free skin conditioning or active agent(s) or a blend thereof (defined as being present outside the flake) having a weight average particle size in the range of about 1 to about 500 microns. More preferably the cleansing composition contains about 0.1 to about 15 wt % of the free skin conditioning or active agent(s) or blend thereof. In a preferred embodiment the skin conditioning agent functions as a carrier to deliver skin active agents to skin treated with the composition.

Advantageously the cleansing composition further includes greater than about 30% by weight of water.

Preferably the hydrophilic polysaccharide gel flakes includes an anionic polysaccharide, an anionic polysaccharide derivative or a blend thereof. More preferably the anionic polysaccharide is selected from gellan gum, xanthan gum, guar gum, alginic acid, pectin, xanthan gum, tragacanth gum, gum arabic, karaya gum and blends and derivatives thereof. Most preferably the anionic polysaccharide is gellan gum.

Advantageously the gel flake further includes a skin conditioning agent, a skin active agent or a blend thereof that is a liquid, a semi-solid, or a solid at a temperature of 25 C. Preferably the concentration of total skin conditioning agent(s), skin active agent(s) or a blend thereof in the gel flake is about 0.5% to about 50% by weight of the flake. More preferably the gel flake has an average major axis of about 0.05, 0.1, 0.5, or 1.0 to 10 millimeters. Advantageously the gel flake includes a solid or semi-solid particles selected from uncoated particles, hydrophilically coated particles such as mica, plastic, pigments, blends and aggregates thereof, hydrophobically coated particles, blends and aggregates thereof, preferably the particles are flattened or plate-like. Preferably the gel flake further includes pigments such as TiO2, ZnO2, and the like.

The inventive cleansing composition may have isotropic or ordered crystalline microstructure or a combination thereof. In one embodiment, the inventive composition is a lamellar structured composition and preferably has a low shear viscosity in the range of about 20,000, 30,000, 40,000 or 50,000 to 300,000 centipoises (cps) (25 C) measured at 0.5 RPM using T-bar spindle A using the procedure below as measured without the gel flakes. More preferably the viscosity range is 40,000 or 50,000 to 200,000 cps. In another embodiment, the inventive cleansing composition has isotropic structure and preferably has a viscosity in the range of about 1,000 or 5,000 to 100,000 centipoises (cps) (25 C) measured at 0.5 RPM using a Brookfield Cone and Plate viscometer with spindle number S41 using the procedure below as measured without the gel flakes. More preferably the viscosity range is about 10,000 to 50,000 cps.

In a preferred embodiment a thickening agent is added to the free skin conditioning or active agent(s) in amount from about 1 to about 50% wt. based on the total skin conditioning and active agent(s). Advantageously the thickening agent is selected from polyacrylates; silica, natural and synthetic waxes; aluminum silicate; lanolin derivatives; C8 to C20 fatty alcohols polyethylene copolymers; polyammonium carboxylates; sucrose esters; hydrophobic clays; petrolatum; hydrotalcites; cellulose derivatives, polysaccharide derivatives, and mixtures thereof or any other thickening compound that is compatible with the cleansing composition.

In a further preferred embodiment, the isotropic structured cleansing composition is structured with a structurant selected from swelling clays; cross-linked polyacrylates; acrylate homopolymers and copolymers; polyvinylpyrrolidone homopolymers and copolymers; polyethylene imines; inorganic salts; sucrose esters, and gellants.

In a further preferred embodiment, the ordered liquid crystalline structured cleansing composition is structured with a structurant selected from fatty acids, fatty esters, trihydroxystearin, or fatty alcohols; preferably lauric acid, isostearic acid, trihydroxystearin, palm kernel acid, capric acid, oleic acid, and caprylic acid.

In another aspect of the invention is a method for preparing the inventive cleansing composition including but not limited to the steps of:

a. forming a first composition having at least one hydrophilic polysaccharide component and solid or semi-solid particles;

b. dispersing the ingredients of the first composition by agitation;

c. heating the well suspended first composition to a temperature greater than 60 C, 70 C or preferably 80 C until homogenous;

d. allowing the heated first composition to cool to a temperature less than 70 C; and

e. adding the first composition under agitation to a surfactant cleansing system containing a sufficient amount of cations, preferably polyvalent cations to form gel flakes;

Preferably the inventive method includes but is not limited to the steps of adding a thickening agent to a quantity of free skin conditioning or active agent(s) or blend thereof in an amount from about 1 to 50 wt. %, based on the total skin conditioning and active agent(s) or blend thereof to form a thickened premix; and mixing the first formulation with the thickened premix; especially in the case where the composition has isotropic structure.

In another aspect of the invention is method of depositing a skin conditioning agent, a skin active agent or a blend thereof onto the skin and hair from the inventive cleansing composition which has the conditioning or active agent(s) or blend thereof either within the gel flake particle, outside the gel flake particle or has some combination of the foregoing. This inventive method includes but is not limited to the steps of applying the cleansing composition to the skin or hair and rinsing the composition off the skin with water.

Surfactants:

Surfactants are an essential component of the inventive cleansing composition. They are compounds that have hydrophobic and hydrophilic portions that act to reduce the surface tension of the aqueous solutions they are dissolved in. Useful surfactants can include anionic, nonionic, amphoteric, and cationic surfactants, and blends thereof.

Anionic Surfactants:

The cleansing composition of the present invention contains one or more anionic surfactants. Advantageously the composition contains in the range of about 0.1, 1, 2, 3, 4 or 5 to 15, 20, 30, 40, 50, or 60%, by wt. of total anionic surfactants.

The anionic detergent active which may be used may be aliphatic sulfonates, such as a primary alkane (e.g., C₈-C₂₂) sulfonate, primary alkane (e.g., C₈-C₂₂) disulfonate, C₈-C₂₂ alkene sulfonate, C₈-C₂₂ hydroxyalkane sulfonate or alkyl glyceryl ether sulfonate (AGS); or aromatic sulfonates such as alkyl benzene sulfonate.

The anionic may also be an alkyl sulfate (e.g., C₁₂-C₁₈ alkyl sulfate) or alkyl ether sulfate (including alkyl glyceryl ether sulfates). Among the alkyl ether sulfates are those having the formula:
RO(CH₂CH₂O)ₙSO₃M

wherein R is an alkyl or alkenyl having 8 to 18 carbons, preferably 12 to 18 carbons, n has an average value of greater than 1.0, preferably greater than 3; and M is a

solubilizing cation such as sodium, potassium, ammonium or substituted ammonium. Ammonium and sodium lauryl ether sulfates are preferred.

The anionic may also be alkyl sulfosuccinates (including mono- and dialkyl, e.g., C₆-C₂₂ sulfosuccinates); alkyl and acyl taurates, alkyl and acyl sarcosinates, sulfoacetates, C₈-C₂₂ alkyl phosphates and phosphates, alkyl phosphate esters and alkoxyl alkyl phosphate esters, acyl lactates, C₈-C₂₂ monoalkyl succinates and maleates, sulphoacetates, alkyl glucosides and acyl isethionates, and the like.

Sulfosuccinates may be monoalkyl sulfosuccinates having the formula:
R⁴O₂CCH₂CH(SO₃M)CO₂M; and
amide-MEA sulfosuccinates of the formula;
   R⁴CONHCH₂CH₂O₂CCH₂CH(SO₃M)CO₂M
wherein R⁴ ranges from C₈-C₂₂ alkyl and M is a solubilizing cation.
Sarcosinates are generally indicated by the formula:
   R¹CON(CH₃)CH₂CO₂M,
wherein R¹ ranges from C₈-C₂₀ alkyl and M is a solubilizing cation.
Taurates are generally identified by formula:
   R²CONR³CH₂CH₂SO₃M

wherein R² ranges from C₈-C₂₀ alkyl, R³ ranges from C₁-C₄ alkyl and M is a solubilizing cation.

Another anionic surfactant that may be used is a C₈-C₁₈ acyl isethionates. These esters are prepared by reaction between alkali metal isethionate with mixed aliphatic fatty acids having from 6 to 18 carbon atoms and an iodine value of less than 20. At least 75% of the mixed fatty acids have from 12 to 18 carbon atoms and up to 25% have from 6 to 10 carbon atoms.

The acyl isethionate may be an alkoxylated isethionate such as is described in Ilardi et al., U.S. Pat. No. 5,393,466, titled “Fatty Acid Esters of Polyalkoxylated isethonic acid; issued Feb. 28, 1995; hereby incorporated by reference. This compound has the general formula:
RC—O(O)—CH(X)—CH₂—(OC(Y)H—CH₂)ₘ—SO₃M⁺

wherein R is an alkyl group having 8 to 18 carbons, m is an integer from 1 to 4, X and Y are hydrogen or an alkyl group having 1 to 4 carbons and M⁺ is a monovalent cation such as, for example, sodium, potassium or ammonium.

Amphoteric Surfactants

One or more amphoteric surfactants may be used in this invention. Advantageously the composition contains in the range of 0 to about 15, 20 or 30%, preferably about 2-8% and most preferably about 4-5% by wt. of total amphoteric surfactants. Such surfactants include at least one acid group. This may be a carboxylic or a sulphonic acid group. They include quaternary nitrogen and therefore are quaternary amido acids. They should generally include an alkyl or alkenyl group of 7 to 18 carbon atoms. They will usually comply with an overall structural formula:
R¹—[—C(O)—NH(CH₂)ₙ—]ₘ—N⁺—(R²)(R³)X—Y
where R¹ is alkyl or alkenyl of 7 to 18 carbon atoms;
R² and R³ are each independently alkyl, hydroxyalkyl or carboxyalkyl of 1 to 3 carbon atoms;
n is 2 to 4;
m is 0 to 1;

X is alkylene of 1 to 3 carbon atoms optionally substituted with hydroxyl, and
Y is —CO₂— or —SO₃—

Suitable amphoteric surfactants within the above general formula include simple betaines of formula:
R¹—N⁺—(R²)(R³)CH₂CO₂⁻
and amido betaines of formula:
   R¹—CONH(CH₂)ₙ—N⁺—(R²)(R³)CH₂CO₂⁻
where n is 2 or 3.

In both formulae R¹, R² and R³ are as defined previously. R¹ may in particular be a mixture of C₁₂ and C₁₄ alkyl groups derived from coconut oil so that at least half, preferably at least three quarters of the groups R¹ have 10 to 14 carbon atoms. R² and R³ are preferably methyl.

A further possibility is that the amphoteric detergent is a sulphobetaine of formula:
R¹—N⁺—(R²)(R³)(CH₂)₃SO₃⁻
or
R¹—CONH(CH₂)ₘ—N⁺—(R²)(R³)(CH₂)₃SO₃⁻
where m is 2 or 3, or variants of these in which —(CH₂)₃ SO₃⁻ is replaced by
   —CH₂C(OH)(H)CH₂SO₃⁻

In these formulae R¹, R² and R³ are as discussed previously.

Amphoacetates and diamphoacetates are also intended to be covered in possible zwitterionic and/or amphoteric compounds which may be used such as e.g., sodium lauroamphoacetate, sodium cocoamphoacetate, and blends thereof, and the like.

Nonionic Surfactants

One or more nonionic surfactants may also be used in the cleansing composition of the present invention. Advantageously the composition contains 0 to about 5, 10, 15, 20 or 30%, preferably about 0.5-5% and most preferably about 1-2% by wt. of total nonionic surfactants.

The nonionics which may be used include in particular the reaction products of compounds having a hydrophobic group and a reactive hydrogen atom, for example aliphatic alcohols, acids, amides or alkylphenols with alkylene oxides, especially ethylene oxide either alone or with propylene oxide. Specific nonionic detergent compounds are alkyl (C₆-C₂₂) phenols ethylene oxide condensates, the condensation products of aliphatic (C₈-C₁₈) primary or secondary linear or branched alcohols with ethylene oxide, and products made by condensation of ethylene oxide with the reaction products of propylene oxide and ethylenediamine. Other so-called nonionic detergent compounds include long chain tertiary amine oxides, long chain tertiary phosphine oxides and dialkyl sulphoxide, and the like.

The nonionic may also be a sugar amide, such as a polysaccharide amide. Specifically, the surfactant may be one of the lactobionamides described in U.S. Pat. No. 5,389,279 to Au et al. titled “Compositions Comprising Nonionic Glycolipid Surfactants issued Feb. 14, 1995; which is hereby incorporated by reference or it may be one of the sugar amides described in U.S. Pat. No. 5,009,814 to Kelkenberg, titled “Use of N-Poly Hydroxyalkyl Fatty Acid Amides as Thickening Agents for Liquid Aqueous Surfactant Systems” issued Apr. 23, 1991; hereby incorporated into the subject application by reference.

Cationic Skin Conditioning Agents

An optional component in compositions according to the invention is a cationic skin feel agent or polymer. Advantageously the composition contains in the range of 0 to about 2, 3, 4 or 5%, preferably about 0.05 to 1% and most preferably about 0.1 to 0.7% by wt. of total cationic skin feel agent or polymer(s). Useful examples are cationic celluloses. Cationic cellulose is available from Amerchol Corp. (Edison, N.J., USA) in their Polymer JR (trade mark) and LR (trade mark) series of polymers, as salts of hydroxyethyl cellulose reacted with trimethyl ammonium substituted epoxide, referred to in the industry (CTFA) as Polyquaternium 10. Another type of cationic cellulose includes the polymeric quaternary ammonium salts of hydroxyethyl cellulose reacted with lauryl dimethyl ammonium-substituted epoxide, referred to in the industry (CTFA) as Polyquaternium 24. These materials are available from Amerchol Corp. (Edison, N.J., USA) under the tradename Polymer LM-200.

A particularly suitable type of cationic polysaccharide polymer that can be used is a cationic guar gum derivative, such as guar hydroxypropyltrimonium chloride (Commercially available from Rhone-Poulenc in their JAGUAR trademark series). Examples are JAGUAR C13S, which has a low degree of substitution of the cationic groups and high viscosity, JAGUAR C15, having a moderate degree of substitution and a low viscosity, JAGUAR C17 (high degree of substitution, high viscosity), JAGUAR C16, which is a hydroxypropylated cationic guar derivative containing a low level of substituent groups as well as cationic quaternary ammonium groups, and JAGUAR 162 which is a high transparency, medium viscosity guar having a low degree of substitution.

Particularly preferred cationic polymers are JAGUAR C13S, JAGUAR C15, JAGUAR C17 and JAGUAR C16 and JAGUAR C162, especially Jaguar C13S. Other cationic skin feel agents known in the art may be used provided that they are compatible with the inventive formulation.

Thickening Agents

Suitable thickening agents can be added either directly to the skin conditioning or active agent(s) or as a structurant for the inventive isotropic composition or both. Suitable thickening agents for the skin conditioning or active agent(s) include polacrylates; fumed silica natural and synthetic waxes, alkyl silicone waxes such as behenyl silicone wax; aluminum silicate; lanolin derivatives such as lanesterol; C8 to C20 fatty alcohols; polyethylenecopolymers; polyammonium stearate; sucrose esters; hydrophobic clays; petrolatum; hydrotalcites; and mixtures thereof, and the like.

Hydrotalcites are materials of general formula:
[MₘNₙ(OH)..₂₍ₘ₊ₙ₎].ⁿ+X.^{m}-.sub._{n/m}yH₂O
where
M is a divalent metal ion e.g. Mg.²⁺;
N is a trivalent metal ion e.g. Al.³⁺;
X is an exchangeable anion e.g. CO.₃^{.-}, NO.₃.⁻, stearate, cinnimate;
m is the number of divalent metal ions; and
n is the number of trivalent metal ions.

Particularly preferred thickening agents for the skin conditioning or active agent(s) include silica, alkyl silicone waxes, paraffin wax C8 to C20 fatty alcohols, petroleum jelly and polyethylene copolymers, and the like.

While some materials can function as both a skin conditioning or active agent and a thickener therefor it will be appreciated that the skin conditioning or active agent(s) and thickening function cannot be provided by the same component. However, it will be understood that where the composition comprises two or more skin conditioning or active agent(s) one of said skin conditioning or active agent(s) could also function as a thickening agent.

Although the compositions of the invention may be self-structuring preferably they will also comprise a structurant, i.e. a material added to increase the viscosity at zero shear. Suitable materials include swelling clays, for example laponite; fatty acids and derivatives hereof and, in particular fatty acid monoglyceride polyglycol ethers; cross-linked polyacrylates such as Carbopol (.TM.) (polymers available from Goodrich); acrylates and copolymers thereof, polyvinylpyrrolidone and copolymers thereof; polyethylene imines; salts such as sodium chloride and ammonium sulphate; sucrose esters; gellants; and mixtures thereof, and the like.

Of the clays particularly preferred are synthetic hectorite (laponite) clay used in conjunction with an electrolyte salt capable of causing the clay to thicken. Suitable electrolytes include alkali and alkaline earth salts such as halides, ammonium salts and sulphates, and the like.

As mentioned above compositions according to the invention may also comprise a thickening agent in addition to the thickening agent added to the skin conditioning or active agent(s), i.e. a material which maintains the viscosity of the composition as the shear rate thereof is increased during use. Suitable materials include cross-linked polyacrylates such as Carbopol (.TM.) (polymers available from Goodrich); fatty acids and derivatives thereof, and the like, and, in particular, fatty acid monoglyceride polyglycol ethers; natural gums including alginates, guar, xanthan and polysaccharide derivatives including carboxy methyl cellulose and hydroxypropyl guar; propylene glycols and propylene glycol oleates, and the like; salts such as sodium chloride and ammonium sulphate; glycerol tallowates; and mixtures thereof, and the like.

Further examples of structurants and thickeners are given in the International Cosmetic Ingredient Dictionary, Fifth Edition, 1993, published by CTFA (The Cosmetic, Toiletry & Fragrance Association), incorporated herein by reference.

Cationic Surfactants

One or more cationic surfactants may also be used in the cleansing composition. Advantageously the composition contains in the range of 0 to about 5, 10, 15 or 20% by wt., preferably 0 to about 1% and most preferably about 0 to about 0.5% by wt. of total cationic surfactants.

Examples of cationic detergents are the quaternary ammonium compounds such as alkyldimethylammonium halogenides.

Other suitable surfactants which may be used are described in U.S. Pat. No. 3,723,325 to Parran Jr. titled “Detergent Compositions Containing Particle Deposition Enhancing Agents” issued March, 27, 1973; and “Surface Active Agents and Detergents” (Vol. I & II) by Schwartz, Perry & Berch, both of which are also incorporated into the subject application by reference.

In addition, the inventive cleansing composition of the invention may include 0 to 15% by wt. optional ingredients as follows: perfumes; sequestering agents, such as tetrasodium ethylenediaminetetraacetate (EDTA), EHDP or mixtures in an amount of 0.01 to 1%, preferably 0.01 to 0.05%; and coloring agents, opacifiers and pearlizers such as zinc stearate, magnesium stearate, TiO₂, EGMS (ethylene glycol monostearate) or Lytron 621 (Styrene/Acrylate copolymer) and the like; all of which are useful in enhancing the appearance or cosmetic properties of the product.

The compositions may also comprise coconut acyl mono- or diethanol amides as suds boosters, and strongly ionizing salts such as sodium chloride and sodium sulfate may also be used to advantage.

Antioxidants such as, for example, butylated hydroxytoluene (BHT) and the like may be used advantageously in amounts of about 0.01% or higher if appropriate. Antioxidants may also be present in concentrations effective to be skin active agents.

Hydrophilic Polysaccharides:

Useful hydrophilic polysaccharides that can be employed in the present invention may be based on starch, guar, carob seed grain, tragacanth units, xanthan gum, gum arabic, carboxymethylcellulose, alginates, methylcellulose, karaya gum and the like. Preferably the inventive polysaccharides are made from glucose, glucuronic acid and rhamnose; more preferably in a building block ratio of 2:1:1. Most preferably the inventive polysaccharide contains gellan gum. Gellan gum is a water-soluble polysaccharide obtained by aerobic fermentation from Pseudomonas eludea. The microorganisms are supplied by a nutrient medium with a carbon source, phosphates, organic and inorganic nitrogen compounds and trace elements. Prerequisites for growth conditions are sterile working procedures, the introduction of oxygen, agitation, and temperature and pH control. The fermentation mixture is then pasteurized in order to kill the living cells. Gellan gum is obtained from the fermentation mixture. During the addition reaction of salts onto the carboxyl groups, aggregation of the gel particles takes place. Although not wishing to be bound by any particular mechanism, X-ray diffraction analysis shows that the gel particles have the structure of a laevorotating parallel double helix, which is folded three times. Flake particles having a skin conditioning agent, a skin active agent or a blend thereof can be prepared, for example, by dissolving a hydrophilic polysaccharide in water at a suitable hydration temperature, adding the conditioning or active agent or blend thereof and preparing an emulsion, the emulsion being added dropwise to an aqueous solution of mono or polyvalent salts or a blend thereof present in sufficient concentration to form a gel. Other useful art recognized and equivalent methods of preparing flakes containing conditioning and active agents may be used in any combination.

The ratio of polysaccharide to skin conditioning and/or active agents components are preferably at most 1:50, 1:40, 1:30, 1:20, 1:10, 1:5, 1:1, 2:1 or 10:1. Salts are preferably selected from CaCl₂, MgSO₄, CaSO₄ and MgCl₂. The size of the flakes can be advantageously controlled by the viscosity of surfactant system and the rate of mixing.

Skin Conditioning Agents

Skin conditioning agents defined herein as emollients are advantageously used in the present invention. Advantageously the composition contains in the range of about 0.05-50%, preferably about 1-30% and most preferably about 5-10% by wt. of total hydrophobic and hydrophilic emollients. Suitable hydrophilic emollients include humectants such as polyhydric alcohols, e.g. glycerin and propylene glycol, and the like; polyols such as the polyethylene glycols listed below, and the like and hydrophilic plant extracts and derivatives and blends thereof.

| | |
|---|---|
| Polyox WSR-205 | PEG 14M, |
| Polyox WSR-N-60K | PEG 45M, or |
| Polyox WSR-N-750 | PEG 7M. |

The term “emollient” is defined as a substance which softens or improves the elasticity, appearance, and youthfulness of the skin (stratum corneum) by increasing its water content, and keeps it soft by retarding the decrease of its water content.

Useful hydrophobic emollients include the following:

silicone oils and modifications thereof such as linear and cyclic polydimethylsiloxanes; amino, alkyl, alkylaryl, and aryl silicone oils;

fats and oils including natural fats and oils such as jojoba, soybean, sunflower, rice bran, avocado, almond, olive, sesame, persic, castor, coconut, mink oils; cacao fat; beef tallow, lard; hardened oils obtained by hydrogenating the aforementioned oils; and synthetic mono, di and triglycerides such as myristic acid glyceride and 2-ethylhexanoic acid glyceride;

waxes such as carnauba, spermaceti, beeswax, lanolin, and derivatives thereof;

hydrophobic plant extracts;

hydrocarbons such as liquid paraffin, petrolatum, microcrystalline wax, ceresin, squalene, pristan and mineral oil;

higher fatty acids such as lauric, myristic, palmitic, stearic, behenic, oleic, linoleic, linolenic, lanolic, isostearic, arachidonic and poly unsaturated fatty acids (PUFA);

higher alcohols such as lauryl, cetyl, stearyl, oleyl, behenyl, cholesterol and 2-hexydecanol alcohol;

esters such as cetyl octanoate, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactate, alkyl citrate and alkyl tartrate;

essential oils and extracts thereof such as mentha, jasmine, camphor, white cedar, bitter orange peel, ryu, turpentine, cinnamon, bergamot, citrus unshiu, calamus, pine, lavender, bay, clove, hiba, eucalyptus, lemon, starflower, thyme, peppermint, rose, sage, sesame, ginger, basil, juniper, lemon grass, rosemary, rosewood, avocado, grape, grapeseed, myrrh, cucumber, watercress, calendula, elder flower, geranium, linden blossom, amaranth, seaweed, ginko, ginseng, carrot, guarana, tea tree, jojoba, comfrey, oatmeal, cocoa, neroli, vanilla, green tea, penny royal, aloe vera, menthol, cineole, eugenol, citral, citronelle, borneol, linalool, geraniol, evening primrose, camphor, thymol, spirantol, penene, limonene and terpenoid oils; and

derivatives and mixtures of any of the foregoing components, and the like.

Preferred hydrophobic emollient moisturizing agents are selected from glyceride oils, mineral oils, silicone oils and mixtures thereof.

Skin Active Agents

Advantageously, active agents other than skin conditioning agents defined above may be added to the composition. These active ingredients may be advantageously selected from bactericides, vitamins, anti-acne actives; anti-wrinkle, anti-skin atrophy and skin repair actives; skin barrier repair actives; non-steroidal cosmetic soothing actives; artificial tanning agents and accelerators; skin lightening actives; sunscreen actives; sebum stimulators; sebum inhibitors; anti-oxidants; protease inhibitors; skin tightening agents; anti-itch ingredients; hair growth inhibitors; 5-alpha reductase inhibitors; desquamating enzyme enhancers; anti-glycation agents; or mixtures thereof; and the like.

These active agents may be selected from water soluble active agents, oil soluble active agents, pharmaceutically-acceptable salts and mixtures thereof. The term “active agent” as used herein, means personal care actives which can be used to deliver a benefit to the skin and/or hair and which generally are not used to confer a skin conditioning benefit, such are delivered by emollients as defined above. The term “benefit,” as used herein, means the therapeutic, prophylactic, and/or chronic benefits associated with treating a particular condition with one or more of the active agents described herein. Preferably the compositions of the present invention comprise from about 0.01% to 50%, more preferably from about 0.05% to 25%, even more preferably about 0.1% to 10%, and most preferably about 0.1% % to 5%, by weight of the active agent component. Such components may reside exclusively within the composition outside the gel flake, reside exclusively within the gel flake or be distributed between the two regions.

A wide variety of active agent ingredients are useful herein and include those selected from anti-acne actives, anti-wrinkle and anti-skin atrophy actives, skin barrier repair aids, cosmetic soothing aids, topical anesthetics, artificial tanning agents and accelerators, skin lightening actives, antimicrobial and antifungal actives, sunscreen actives, sebum stimulators, sebum inhibitors, anti-glycation actives and mixtures thereof and the like.

Anti-acne actives can be effective in treating acne vulgaris, a chronic disorder of the pilosebaceous follicles. Nonlimiting examples of useful anti-acne actives include the keratolytics such as salicylic acid (o-hydroxybenzoic acid), derivatives of salicylic acid such as 5-octanoyl salicylic acid and 4 methoxysalicylic acid, and resorcinol; retinoids such as retinoic acid and its derivatives (e.g., cis and trans); sulfur-containing D and L amino acids and their derivatives and salts, particularly their N-acetyl derivatives, mixtures thereof and the like.

Antimicrobial and antifungal actives can be effective to prevent the proliferation and growth of bacteria and fungi. Nonlimiting examples of antimicrobial and antifungal actives include b-lactam drugs, quinolone drugs, ciprofloxacin, norfloxacin, tetracycline, erythromycin, amikacin, 2,4,4′-trichloro-2′-hydroxy diphenyl ether, 3,4,4′-Trichlorocarbanilide (triclocarban), phenoxyethanol, 2,4,4′-Trichloro-2′-Hydroxy Diphenyl Ether (triclosan); and mixtures thereof and the like.

Anti-wrinkle, anti-skin atrophy and skin repair actives can be effective in replenishing or rejuvenating the epidermal layer. These actives generally provide these desirable skin care benefits by promoting or maintaining the natural process of desquamation. Nonlimiting examples of antiwrinkle and anti-skin atrophy actives include vitamins, minerals, and skin nutrients such as milk, vitamins A, E, and K; vitamin alkyl esters, including vitamin C alkyl esters; magnesium, calcium, copper, zinc and other metallic components; retinoic acid and its derivatives (e.g., cis and trans); retinal; retinol; retinyl esters such as retinyl acetate, retinyl palmitate, and retinyl propionate; vitamin B 3 compounds (such as niacinamide and nicotinic acid), alpha hydroxy acids, beta hydroxy acids, e.g. salicylic acid and derivatives thereof (such as 5-octanoyl salicylic acid, heptyloxy 4 salicylic acid, and 4-methoxy salicylic acid); mixtures thereof and the like.

Skin barrier repair actives are those skin care actives which can help repair and replenish the natural moisture barrier function of the epidermis. Nonlimiting examples of skin barrier repair actives include lipids such as cholesterol, ceramides, sucrose esters and pseudo-ceramides as described in European Patent Specification No. 556,957; ascorbic acid; biotin; biotin esters; phospholipids, mixtures thereof, and the like.

Non-steroidal Cosmetic Soothing Actives can be effective in preventing or treating inflammation of the skin. The soothing active enhances the skin appearance benefits of the present invention, e.g., such agents contribute to a more uniform and acceptable skin tone or color. Nonlimiting examples of cosmetic soothing agents include the following categories: propionic acid derivatives; acetic acid derivatives; fenamic acid derivatives; mixtures thereof and the like. Many of these cosmetic soothing actives are described in U.S. Pat. No. 4,985,459 to Sunshine et al., issued Jan. 15, 1991, incorporated by reference herein in its entirety.

Artificial tanning actives can help in simulating a natural suntan by increasing melanin in the skin or by producing the appearance of increased melanin in the skin. Nonlimiting examples of artificial tanning agents and accelerators include dihydroxyacetaone; tyrosine; tyrosine esters such as ethyl tyrosinate and glucose tyrosinate; mixtures thereof, and the like.

Skin lightening actives can actually decrease the amount of melanin in the skin or provide such an effect by other mechanisms. Nonlimiting examples of skin lightening actives useful herein include aloe extract, alpha-glyceryl-L-ascorbic acid, aminotyroxine, ammonium lactate, glycolic acid, hydroquinone, 4 hydroxyanisole, mixtures thereof, and the like.

Also useful herein are sunscreen actives. A wide variety of sunscreen agents are described in U.S. Pat. No. 5,087,445, to Haffey et al., issued Feb. 11, 1992; U.S. Pat. No. 5,073,372, to Turner et al., issued Dec. 17, 1991; U.S. Pat. No. 5,073,371, to Turner et al. issued Dec. 17, 1991; and Segarin, et al., at Chapter VIII, pages 189 et seq., of Cosmetics Science and Technology, all of which are incorporated herein by reference in their entirety. Nonlimiting examples of sunscreens which are useful in the compositions of the present invention are those selected from the group consisting of octyl methoxyl cinnamate (Parsol MCX) and butyl methoxy benzoylmethane (Parsol 1789), 2-ethylhexyl p-methoxycinnamate, 2-ethylhexyl N,N-dimethyl-p-aminobenzoate, p-aminobenzoic acid, 2-phenylbenzimidazole-5-sulfonic acid, oxybenzone, mixtures thereof, and the like.

Sebum stimulators can increase the production of sebum by the sebaceous glands. Nonlimiting examples of sebum stimulating actives include bryonolic acid, dehydroepiandrosterone (DHEA), orizanol, mixtures thereof, and the like.

Sebum inhibitors can decrease the production of sebum by the sebaceous glands. Nonlimiting examples of useful sebum inhibiting actives include aluminum hydroxy chloride, corticosteroids, dehydroacetic acid and its salts, dichlorophenyl imidazoldioxolan (available from Elubiol), mixtures thereof, and the like.

Also useful as actives in the present invention are protease inhibitors. Protease inhibitors can be divided into two general classes: the proteinases and the peptidases. Proteinases act on specific interior peptide bonds of proteins and peptidases act on peptide bonds adjacent to a free amino or carboxyl group on the end of a protein and thus cleave the protein from the outside. The protease inhibitors suitable for use in the present invention include, but are not limited to, proteinases such as serine proteases, metalloproteases, cysteine proteases, and aspartyl protease, and peptidases, such as carboxypepidases, dipeptidases and aminopepidases, mixtures thereof and the like.

Other useful as active ingredients in the present invention are skin tightening agents. Nonlimiting examples of skin tightening agents which are useful in the compositions of the present invention include monomers which can bind a polymer to the skin such as terpolymers of vinylpyrrolidone, (meth)acrylic acid and a hydrophobic monomer comprised of long chain alkyl (meth)acrylates, mixtures thereof, and the like.

Active ingredients in the present invention may also include anti-itch ingredients. Suitable examples of anti-itch ingredients which are useful in the compositions of the present invention include hydrocortisone, methdilizine and trimeprazine, mixtures thereof, and the like.

Nonlimiting examples of hair growth inhibitors which are useful in the compositions of the present invention include 17 beta estradiol, anti angiogenic steroids, curcuma extract, cycloxygenase inhibitors, evening primrose oil, linoleic acid and the like. Suitable 5-alpha reductase inhibitors such as ethynylestradiol and, genistine mixtures thereof, and the like.

Nonlimiting examples of desquamating enzyme enhancers which are useful in the compositions of the present invention include alanine, aspartic acid, N methyl serine, serine, trimethyl glycine, mixtures thereof, and the like.

A nonlimiting example of an anti-glycation agent which is useful in the compositions of the present invention would be Amadorine (available from Barnet Products Distributor), and the like.

Exfoliants

The inventive composition may contain particles that are greater than 50 microns in average diameter that help remove dry skin. Not being bound by theory, the degree of exfoliation depends on the size and morphology of the particles. Large and rough particles are usually very harsh and irritating. Very small particles may not serve as effective exfoliants. Such exfoliants used in the art include natural minerals such as silica, talc, calcite, pumice, tricalcium phosphate; seeds such as rice, apricot seeds, etc; crushed shells such as almond and walnut shells; oatmeal; polymers such as polyethylene and polypropylene beads, flower petals and leaves; microcrystalline wax beads; jojoba ester beads, and the like. These exfoliants come in a variety of particle sizes and morphology ranging from micron sized to a few mm. They also have a range of hardness. Such exfoliants may reside exclusively within the composition outside the gel flake, reside exclusively within the gel flake or be distributed between the two regions. Some examples are given in table A below.

TABLE A

| Material | Hardness (Mohs) |
|---|---|
| Talc | 1 |
| Calcite | 3 |
| Pumice | 4-6 |
| Walnut Shells | 3-4 |
| Dolomite | 4 |
| Polyethylene | ˜1 |

Lamellar and Isotropic Compositions:

As discussed above, the inventive composition may have isotropic structure or ordered, liquid crystalline microstructure or some combination thereof. The rheological behavior of all surfactant solutions, including liquid cleansing solutions, is strongly dependent on the microstructure, i.e., the shape and concentration of micelles or other self-assembled structures in solution.

When there is sufficient surfactant to form micelles (concentrations above the critical micelle concentration or CMC), for example, spherical, cylindrical (rod-like) or discoidal micelles may form characterized by an isotropic distribution. As surfactant concentration increases, ordered liquid crystalline phases such as lamellar phase, hexagonal phase or cubic phase may form. The lamellar phase, for example, consists of alternating surfactant bilayers and water layers. These layers are not generally flat but fold to form submicron spherical onion like structures called vesicles or liposomes. The hexagonal phase, on the other hand, consists of long cylindrical micelles arranged in a hexagonal lattice. In general, the microstructure of most personal care products consist of either spherical micelles; rod micelles; or a lamellar dispersion.

As noted above, micelles may be spherical or rod-like. Formulations having spherical micelles tend to have a low viscosity and exhibit Newtonian shear behavior (i.e., viscosity stays constant as a function of shear rate; thus, if easy pouring of product is desired, the solution is less viscous and, as a consequence, it doesn't suspend as well). In these systems, the viscosity increases linearly with surfactant concentration.

Rod micellar solutions are more viscous because movement of the longer micelles is restricted. At a critical shear rate, the micelles align and the solution becomes shear thinning. Addition of salts increases the size of the rod micelles thereof increasing zero shear viscosity (i.e., viscosity when sitting in bottle) which helps suspend particles but also increases critical shear rate (point at which product becomes shear thinning; higher critical shear rates means product is more difficult to pour).

Lamellar dispersions differ from both spherical and rod-like micelles because they can have high zero shear viscosity (because of the close packed arrangement of constituent lamellar droplets), yet these solutions are very shear thinning (readily dispense on pouring). That is, the solutions can become thinner than rod micellar solutions at moderate shear rates.

In formulating liquid cleansing compositions, therefore, there is the choice of using rod-micellar solutions (whose zero shear viscosity, e.g., suspending ability, is not very good and/or are not very shear thinning); or lamellar dispersions (with higher zero shear viscosity, e.g. better suspending, and yet are very shear thinning). Such lamellar compositions are characterized by high zero shear viscosity (good for suspending and/or structuring) while simultaneously being very shear thinning such that they readily dispense in pouring. Such compositions possess a “heaping”, lotion-like appearance which convey signals of enhanced moisturization.

To form such lamellar compositions, however, some compromises have to be made. First, generally higher amounts of surfactant are required to form the lamellar phase. Thus, it is often needed to add auxiliary surfactants and/or salts which are neither desirable nor needed. Second, only certain surfactants will form this phase and, therefore, the choice of surfactants is restricted.

In short, lamellar compositions are generally more desirable (especially for suspending emollient and for providing consumer aesthetics), but more expensive in that they generally require more surfactant and are more restricted in the range of surfactants that can be used.

When rod-micellar solutions are used, they also often require the use of external structurants to enhance viscosity and to suspend particles (again, because they have lower zero shear viscosity than lamellar phase solutions). For this, carbomers and clays are often used. At higher shear rates (as in product dispensing, application of product to body, or rubbing with hands), since the rod-micellar solutions are less shear thinning, the viscosity of the solution stays high and the product can be stringy and thick. Lamellar dispersion based products, having higher zero shear viscosity, can more readily suspend emollients and are typically more creamy. Again, however, they are generally more expensive to make (e.g., they are restricted as to which surfactants can be used and often require greater concentration of surfactants).

In general, lamellar phase compositions are easy to identify by their characteristic focal conic shape and oily streak texture while hexagonal phase exhibits angular fan-like texture. In contrast, micellar phases are optically isotropic as mentioned above.

It should be understood that lamellar phases may be formed in a wide variety of surfactant systems using a wide variety of lamellar phase “inducers” as described, for example, in U.S. Pat. No. 5,952,286 issued to Puwada, et al., on Sep. 14, 1999. Generally, the transition from micelle to lamellar phase are functions of effective average area of headgroup of the surfactant, the length of the extended tail, and the volume of tail. Using branched surfactants or surfactants with smaller headgroups or bulky tails are also effective ways of inducing transitions from rod micellar to lamellar.

One way of characterizing lamellar dispersions include measuring viscosity at low shear rate (using for example a Stress Rheometer) when additional inducer (e.g., oleic acid or isostearic acid) is used. At higher amounts of inducer, the low shear viscosity will significantly increase.

Another way of characterizing lamellar dispersions is using freeze fracture electron microscopy. Micrographs generally will show lamellar microstructure and close packed organization of the lamellar droplets (generally in size range of about 2 microns).

In contrast to lamellar surfactant solutions described above, isotropic surfactant solutions are composed of completely miscible components whose microstructure does not vary with distance or direction in the solution. Upon comparison of the lamellar and isotropic compositions, it is found that lamellar structures do not lather as well as isotropic structures and isotropic structures do not deposit skin care ingredients in the same manner as lamellar structures.

Lamellar Structurant

The optional lamellar compositions of the invention utilize preferably about 0.3% to 15% by wt., more preferably 0.5 to 5% by wt. of a structuring agent which functions in the lamellar compositions to form a lamellar phase. Such lamellar phase enables its composition to suspend particles more readily (e.g., emollient particles) while still maintaining good shear thinning properties. The lamellar phase also provides consumers with desired rheology (“heaping”).

The structurant is preferably a fatty acid or ester derivative thereof, a fatty alcohol, or trihydroxystearin, and the like. More preferably the structurant is selected from the group consisting of lauric or isostearic acid, or trihydroxystearin.

Examples of fatty acids which may be used are C₁₀-C₂₂ acids such as the following: lauric acid, oleic acid, isostearic acid, linoleic acid, linolenic acid, ricinoleic acid, elaidic acid, arichidonic acid, myristoleic acid and palmitoleic acid, and the like. Ester derivatives include propylene glycol isostearate, propylene glycol oleate, glyceryl isostearate, glyceryl oleate and polyglyceryl diisostearate, and the like.

The invention will now be described in greater detail by way of the following non-limiting examples. The examples are for illustrative purposes only and not intended to limit the invention in any way.

Except in the examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

All percentages in the specification and examples are intended to be by weight unless stated otherwise.

### EXAMPLE 1

Examples of inventive isotropic cleansing compositions were prepared by variously combining the polysaccharide solutions described of Table 1 with the surfactant bases described in Table 2 using the method provided below. All concentrations are expressed as % by wt.

TABLE 1
Polysaccharide Solutions 1-4:

| Component | 1 | 2 | 3 |
|---|---|---|---|
| Gellan | 1 | 1.5% | 1 |
| Gum* | | | |
| EDTA | .02% | .02% | .02% |
| NaOH | 0.05% | 0.05% | 0.05% |
| Preservatives | 0.1% | 0.1% | 0.1% |
| Pigment** | 5% Timeron | 5% Timeron | 10% Timeron |
| | MP-24 (Rona) | MP-149 (Rona) | MP-149 (Ron [symbol] |
| | | 1% DG-R228 (Day Glo) | |
| Water | q.s. to 100% | q.s. to 100% | q.s. to 100% |

*KELCOGEL obtained from CP Kelco (Wilmington, DE, USA)
**Timeron obtained from EMD Chmicals (Hawthorn, NY, USA), DG-R228 obtained from DayGlo (Cleveland, OH)

TABLE 2
Surfactant Bases A & B:

| Component | A | B |
|---|---|---|
| Ammonium Lauryl Sulfate | | 0.1-20.00% |
| Ammonium Laureth Sulfate | | 0.1-20.00% |
| Sodium Laureth Sulfate | 0.1-15.00% | |
| Cocamidopropyl Betaine | 0.00-5.00% | 0.00-5.00% |
| Coconut Monoethanolamide | | 0.00-1.00% |
| Peg-5 Cocamide | | 0.00-2.00% |
| Ethyl Acrylate/Methacrylic Acid | 1.00-2.50% | 1.00-2.50% |
| Copolymer | | |
| Fragrance | 0.80% | 0.80% |
| Glycerin | | 0.00-5.00% |
| Cationic Polymer(1) | | 0.00-0.50% |
| Peg-14M | | 0.00-0.30% |
| Polysaccharide Solution (Table 1) | 0.10-1.00% | 0.10-1.00% |
| Polyvalent cationic species(2) | 0.0001-1.00% | 0.0001-1.00% |
| Acidic or basic compound(s) to | 0.20% | 0.10% |
| adjust to 6.50 pH | | |
| Additional Ingredients (Color, | 0.00-1.00% | 0.00-1.00% |
| Extracts, etc) | | |
| Water | q.s. to 100% | q.s. to 100% |

(1)Mackpro WWP (Wheatgermamidopropyl Dimethylamine Hydrolyzed Wheat Protein) obtained from McIntyre (University Park, IL)
(2)Such as e.g. Ca, Mg or other polyvalent cations and blends thereof present at concentration levels that are compatible with the other components.

Process:
Preparation of Surfactant or Cleansing Base:

Into a mixing vessel, add water and the acrylates copolymer if present and mix until homogenous. Then add all anionic surfactants. Begin to heat the vessel until contents have reached 60 C and then neutralize with adequate amount of an acidic or basic compound to adjust the pH to 6.50. Add all remaining surfactants and mix until homogeneous. Any remaining polymers if present (e.g. cationic or non-ionic) are premixed with a water-soluble liquid such as glycerin and added to the warmed mixing vessel. The contents of the vessel are allowed to cool to 40.5 C when the remainder of the ingredients are added and mixed until homogeneous. The base is then allowed to cool to room temperature before adding the polysaccharide solution as the last step.

Preparation of the Inventive Cleansing Composition:

1) Prepare an overhead mixer and mixing vessel with Surfactant or Cleansing Base as follows:

a) 1000 ml beaker with 1000 mls of surfactant base at 25 C
b) 3.5 in diameter mixing propeller approximately positioned 2.5 to 3.7 cm below surface of surfactant base
   2) Begin mixing at 30 rpm
   3) Slowly add dropwise (˜0.05 g)/sec of the polysaccharide solution (at 25 C) to the top of surfactant base approximately 5 cm from the rotating mixer shaft until the desired quantity has been added.
   4) Varying distance from the mixing shaft will change size and shape of flake
   5) Continue to mix until homogenous (approximately 10 min).

### EXAMPLE 3

Examples of inventive lamellar cleansing compositions may be prepared by variously combining the polysaccharide solutions described in Table 1 with the cleansing composition bases described in Tables 3A and 3B using the method provided above. All concentrations are expressed as % by wt. The T-bar viscosity of the lamellar cleansing composition bases are predicted to be approx. 80,000 cps (25° C.) for 3A and 118,400 cps (25° C.) for 3B prior to adding the polysaccharide solutions.

TABLE 3A

| Chemical or INCI Name | Active % in Formulation |
|---|---|
| Sodium Lauroamphoacetate | 13.50 |
| Sodium Laureth Sulfate | 9.00 |
| Lauric Acid | 1.90 |
| Sunflower Seed oil | 15.00 |
| Glycerin | 2.00 |
| Guar Hydroxypropyl trimonium chloride | 0.50 |
| Citric Acid | 1.70 |
| Titanium Dioxide | 0.10 |
| DMDM Hydantoin + Iodopropynyl | 0.20 |
| Butylcarbamate | |
| EDTA | 0.02 |
| EHDP (Etidronic Acid) | 0.02 |
| Polyvalent cationic species(1) | 0.0001-1.00% |
| Perfume | 1.00 |
| WATER | q.s. 100 |

(1)Such as e.g. Ca, Mg or other polyvalent cations and blends thereof present at concentration levels that are compatible with the other components.

TABLE 3B

| Chemical or INCI Name | Active % in Formulation |
|---|---|
| Sodium Lauroamphoacetate | 5.00 |
| Sodium Laureth Sulfate | 10.00 |
| Cocamide MEA | 2.00 |
| Lauric Acid | 2.80 |
| Sunflower Seed oil | 5.00 |
| Crodalan LA | 1.00 |
| Glycerin | 2.00 |
| Guar Hydroxypropyl trimonium chloride | 0.50 |
| Citric Acid | 1.00 |
| DMDM Hydantoin + Iodopropynyl | 0.22 |
| Butylcarbamate | |
| EDTA | 0.02 |
| EHP (Etidronic Acid) | 0.02 |
| Polyvalent cationic species(1) | 0.0001-1.00% |
| Perfume | 1.00 |
| WATER | q.s. 100 |

(1)Such as e.g. Ca, Mg or other polyvalent cations and blends thereof present at concentration levels that are compatible with the other components.

Methods:

Assessment of product stability was done by visual assessment based on 2-phase separation of the base and flakes settling or creaming to the top. The ‘creaming’ rate of the flakes was evaluated using an accelerated aging test under one or more of the following storage conditions:
1. 51.7 C for a period of 1 month
2. 40.5 C for a period of 1 month
3. −9.5 C/25 C—3 complete cycles where 1 cycle constitute 23.5 hours under −9.5 C followed by another 23.5 hours under 25 C
4. 40.5 C/25 C—3 complete cycles

Stability evaluation is performed visually by comparing the samples stored under the specified accelerated conditions and the control sample (stored at 25 C)

Size Determination

A microscope, a microscope slide and a microscope coverslip are required. A coverslip is placed on top of the slide. A single particle is obtained from the sample and placed on top of the coverslip. Using the microscope and a 10× objective, the diameter of the particle is measured.

Perceived Flake Softness/Hardness and Ease of Spreadability During Use.

Panelists pour flakes (about 10 to 20) between the thumb and either the index and/or middle finger and press them gently between the fingers until the particles rupture. The panelist then rate the flakes degree of softness/hardness based on the following rating scale—Very Hard, Hard, Just Right, Soft and Very Soft. Then the panelists squeeze the ruptured flakes in circular motion between fingers.

To assess the flakes' ease of spreadability, a small amount of sample (about 10 to 20 flakes) is poured onto the back of one of the palms of a panelist. Then these particles are squeezed gently, using forward and backward motions, against the back of the palm with the middle finger and/or the index finger of the other hand. Once the particles are completely spread over the back of the palm, the panelist will rate them for ease of spreadability using the following scale: Unacceptable, Slightly acceptable and highly acceptable. In a preferred embodiment, the inventive compositions contain a majority of flakes that are either slightly or preferably highly acceptable or have hardness values consistent therewith as determined by art recognized or equivalent measurement techniques.

T-Bar Viscosity Measurement

Scope:

This method covers the measurement of the viscosity of the inventive lamellar or other ordered phase composition without polysaccharide flakes.

Apparatus:

Brookfield RVT Viscometer with Helipath Accessory;

Chuck, weight and closer assembly for T-bar attachment;

T-bar Spindle A;

Plastic cups diameter greater than 2.5 inches.

Procedure:

1. Verify that the viscometer and the helipath stand are level by referring to the bubble levels on the back of the instrument.
2. Connect the chuck/closer/weight assembly to the Viscometer (Note the left-hand coupling threads).
3. Clean Spindle A with deionized water and pat dry with a Kimwipe® sheet. Slide the spindle in the closer and tighten.
4. Set the rotational speed at 0.5 RPM. In case of a digital viscometer (DV) select the % mode and press autozero with the motor switch on.
5. Place the product in a plastic cup with inner diameter of greater than 2.5 inches. The height of the product in the cup should be at least 3 inches. The temperature of the product should be 25° C.
6. Lower the spindle into the product (˜¼ inches). Set the adjustable stops of the helipath stand so that the spindle does not touch the bottom of the plastic cup or come out of the sample.
7. Start the viscometer and allow the dial to make one or two revolutions before turning on the Helipath stand. Note the dial reading as the helipath stand passes the middle of its downward traverse.
8. Multiply the dial reading by a factor of 4,000 and report the viscosity reading in cps.
   Cone and Plate Viscosity Measurement
   Scope:

This method covers the measurement of the viscosity of the inventive isotropic phase composition without polysaccharide flakes.

Apparatus:

Brookfield Cone and Plate DV-II+ Viscometer;

Spindle S41;

Plastic cups diameter greater than 2.5 inches.

Procedure:

1. Turn on Water Bath attached to the sample cup of the viscometer. Make sure that it is set for 25° C. Allow temperature readout to stabilize at 25° C. before proceeding.
2. With the power to the viscometer off, remove the spindle (S41) by turning counterclockwise.
3. Turn the power on and press any key as requested to autozero the viscometer.
4. When the autozero function is complete, replace the spindle (turning clockwise) and press any key.
5. Attach the sample cup. Using the up/down arrow keys, slowly change the speed to 10 rpm and press the SET SPEED key. Use the SELECT DISPLAY key so that the display is in % mode.
6. Turn the motor on. If the display jumps to 0.4% or higher or will not settle to 0±0.1%, turn the adjustment ring clockwise until it does.
7. Rotate the adjustment ring counterclockwise until the reading is fluctuating between 0.0 and 1.0%. The fluctuation must occur approximately every 6 seconds.
8. Turn the adjustment ring clockwise exactly the width of one division from the setting reached in step 7.
9. Turn the motor off. Using the up/down arrow keys, slowly change the speed to 0.5 rpm and press the SET SPEED key. Use the SELECT DISPLAY so that the display is in cP.
10. Place 2±0.1 g of product to be measured into the sample cup. Attach the cup to the viscometer.
11. Allow the product to remain in the cup with the motor OFF for 2 minutes.
12. Turn the motor ON and allow the spindle to turn for 2 minutes before noting the reading on the display.

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

We claim:

1. An aqueous liquid cleansing composition comprising:
a. at least about 0.1% by wt. of total surfactant(s) selected from anionic, nonionic, amphoteric and cationic surfactant(s) and mixtures thereof;
b. about 0.1 to 80% by weight of hydrophilic polysaccharide gel flakes with an average major axis of at least about 0.05 to 100 millimeters in length; and
c. wherein at least one solid or semisolid particle having a composition different from the gel flakes is contained at least partially within at least one of the gel flakes.

2. A composition according to claim 1 further comprising free skin conditioning or active agent(s) having a weight average particle size in the range of about 1 to 500 microns.

3. A composition according to claim 1 further comprising greater than about 30% by weight water.

4. A composition according to claim 1 wherein the hydrophilic polysaccharide gel flakes comprises an anionic polysaccacharide, an anionic polysaccharide derivative or a blend thereof.

5. A composition according to claim 1 wherein the anionic polysaccacharide is selected from gellan gum, xanthan gum, guar gum, alginic acid, pectin, xanthan gum, tragacanth gum, gum arabic, karaya gum and blends and derivatives thereof.

6. A composition according to claim 1 wherein the gel flake comprises a skin conditioning agent, a skin active agent or a blend thereof that is a liquid, a semi-solid, or a solid at a temperature of 25° C.

7. A composition according to claim 1 wherein the gel flake comprises a flattened plate-like solid particle selected from uncoated particles, hydrophilically coated particles, hydrophobically coated particles, blends and aggregates thereof.

8. A composition according to claim 7 wherein the solid particle is selected from mica, plastic, pigments, blends and aggregates thereof.

9. A composition according to claim 1 wherein the composition is an isotropic composition.

10. The composition of claim 9 wherein the viscosity as measured without the gel flakes is in the range of about 1,000 to about 300,000 cps @ 1/sec shear rate at 25 C.

11. A composition according to claim 1 wherein the composition is a lamellar structured composition.

12. A composition according to claim 11 wherein the viscosity as measured without the gel flakes is in the range of about 20,000 to 300,000 cps at 25 C as measured by the T-bar viscosity method.

13. A composition according to claim 9 wherein the composition is structured with a structurant selected from swelling clays; cross-linked polyacrylates; acrylate homopolymers and copolymers; polyvinylpyrrolidone homopolymers and copolymers; polyethylene imines; inorganic salts; sucrose esters, and gellants.

14. A composition according to claim 11 wherein the composition is structured with a structurant selected from fatty acids, fatty esters, trihydroxystearin, or fatty alcohols.

15. A composition according to claim 14 wherein the composition is structured with a structurant selected from lauric acid, isostearic acid, trihydroxystearin, palm kernel acid, capric acid, oleic acid, and caprylic acid.

16. A composition according to claim 2 wherein the skin conditioning agent is selected from glyceride oils, esters, mineral oil, petrolatum, silicone oil and mixtures thereof.

17. A composition according to claim 2 having about 0.1 to about 15 wt % of the free skin conditioning or active agent(s).

18. A method for preparing a composition according to claim 1, comprising the steps of:
a. forming a first composition of at least one hydrophilic polysaccharide component and particle(s);
b. dispersing the ingredients of the first composition by agitation;
c. heating the well suspended first composition to a temperature greater that 80 C until homogenous;
d. allowing the heated first composition to cool to a temperature less than 70 C; and
e. adding the first composition under agitation to a surfactant cleansing system containing a sufficient concentration of cations to form gel flakes.

19. A method according to claim 18 where the surfactant cleansing system contains a sufficient amount of polyvalent metal cations to form gel flakes.

20. A method of depositing a skin conditioning agent, a skin active agent or a blend thereof onto the skin and hair from the cleansing composition of claim 2, comprising the steps of applying said cleansing composition to the skin or hair and rinsing the composition off the skin with water.
